(19) United States
(12) Patent Application Publication
(10) Pub. No.: US 2006/0286515 A1
(43) Pub. Date: Dec. 21, 2006

(54) Counting aid

(76) Inventor: Gunther Heil, Weilheim (DE)

Correspondence Address: DEFILLO & ASSOCIATES, INC., 4922 EAGLE COVE SOUTH DRIVE, PALM HARBOR, FL, 34685, US

(21) Appl. No.: 10/563,970

(22) PCT Filed: Jul. 7, 2004
(86) PCT No.: PCT/DE04/01456

§ 371 Date: Apr. 4, 2006

(30) Foreign Application Priority Data
Jul. 10, 2003 (DE) 203 10 598.2

(51) Int. Cl. G09B 1/00

(52) U.S. Cl. 434/207

(57) ABSTRACT

The invention relates to a counting aid. Said aid is made up of various coloured geometric bodies (10, 12, 14) and each body is represented by a number and has a specific geometric form and a specific colour. Each decimal step position (ones, tens, hundreds, thousands) is associated with a specific geometric form, and each number (0-9) is associated with a colour.

The present invention relates to an aid for learning the calculation consisting of differently coloured geometric bodies.

The modern psychology of learning detects increasingly and frequently calculation disorder. With children having such so-called calculation disorder, the learning of calculation is substantially impeded. In this connection already aids for learning the calculation are known consisting of different geometric bodies. With these aids however alone a sufficient success in learning is not possible.

It is therefore the task to be solved by the present invention to improve such aids for learning the calculation in such a way that the success in learning can be substantially increased.

According to the invention, this task is solved by an aid according to the present species for learning the calculation in which each body is representing a figure and is having a definite geometric shape and a definite colour, wherein each decimal step position (e.g. ones, tens, hundreds, thousands) a special geometric shape is allocated and each number (0 to 9) is allocated a colour. In this connection deliberate geometric shapes can be chosen for the respective decimal step positions, wherein however within the aid according to the invention a geometric shape once chosen for the respective decimal position always has to remain the same.

In this connection, it is preferred to choose the geometric shapes of the bodies in such a way that the bodies can be piled up above each other. In this way, the success in learning can be increased further.

In this connection, an allocation is preferred in which the step position “Ones” is assigned the geometric shape “cube”, the step position “Tens” is allocated the geometric shape “cylinder”, the step position “Hundred” the geometric shape “right parallelepiped” and the step position “Thousands” the geometric shape “right parallelepiped having notches”.

Further it is preferred that each body, in addition to the colouring, is inscribed with the corresponding number.

For further increasing the success in learning, additionally tables can be presented on which the numbers are depicted formed by the corresponding bodies or the corresponding two-dimensional areas.

In this connection, it is especially preferred to represent on the tables the numbers 1 to 100 in ten lines and ten columns.

Further, a advantageous solution is achieved if on the tables the numbers 0 to 99 are represented in ten lines and ten columns.

To create the possibility to set further tasks for the children for learning, it is preferred that additionally uncoloured bodies are present having the corresponding geometric shapes.

In the following, the invention is more detailly described with reference to the exemplary embodiment shown in the drawings. In the drawings show:

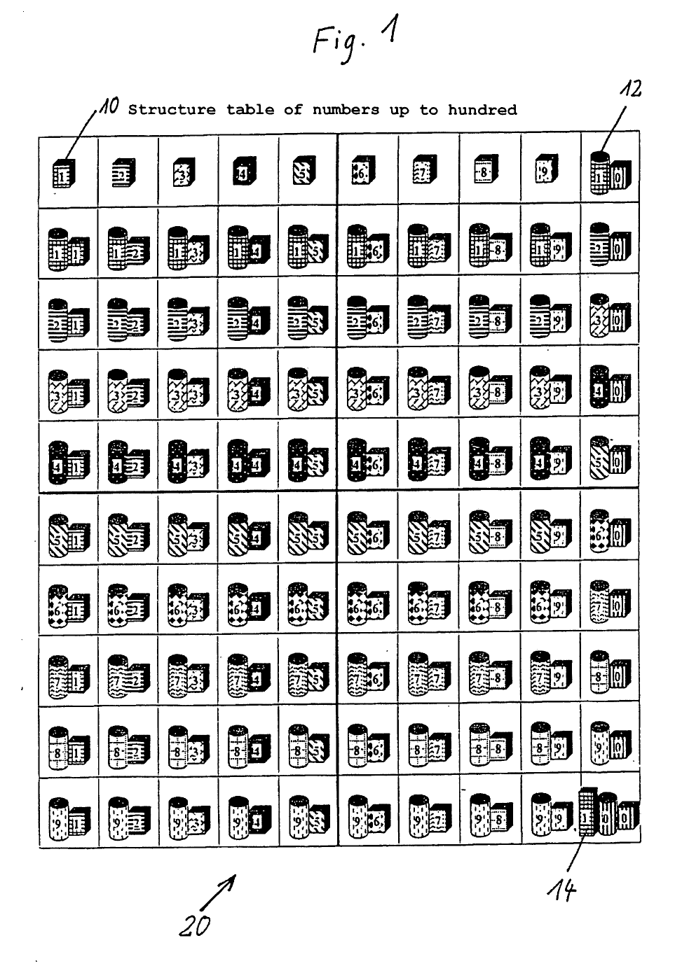

FIG. 1 a structure table of numbers for the numbers 1 to 100, wherein simultaneously the corresponding bodies according to the invention are shown three-dimensionally;

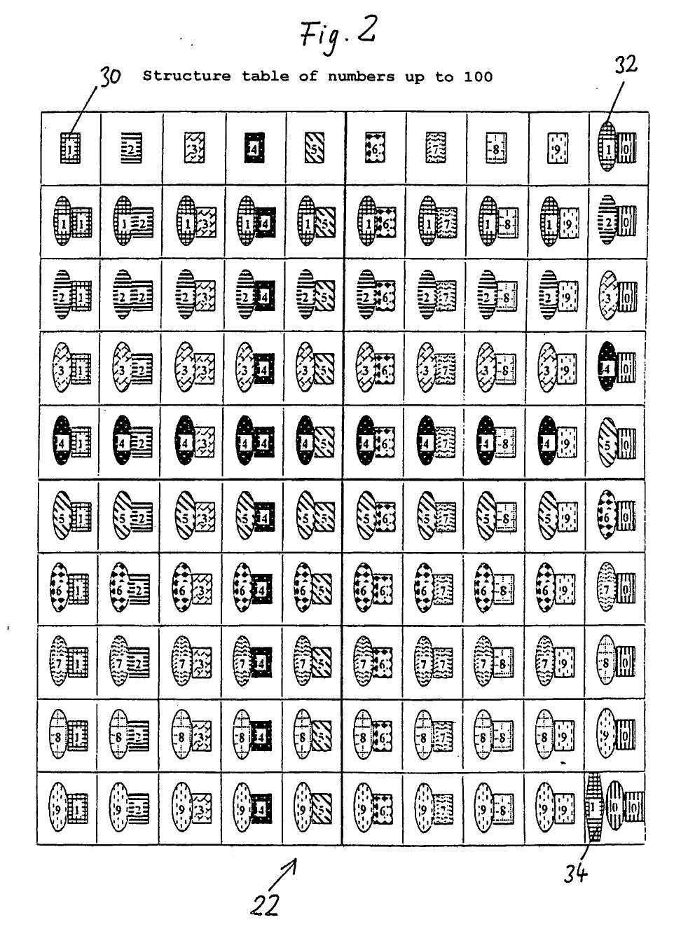

FIG. 2 a simplified form of the structure table of numbers 1 to 100 according to the invention;

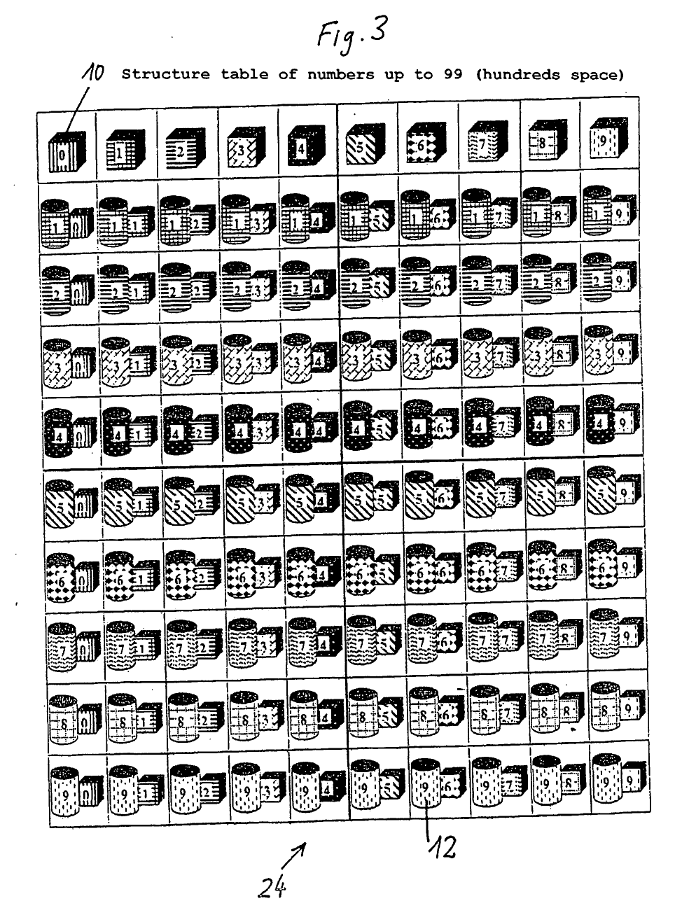

FIG. 3 a structure table of numbers according to the invention for the numbers 0 to 99, wherein the individual bodies are shown three-dimensionally;

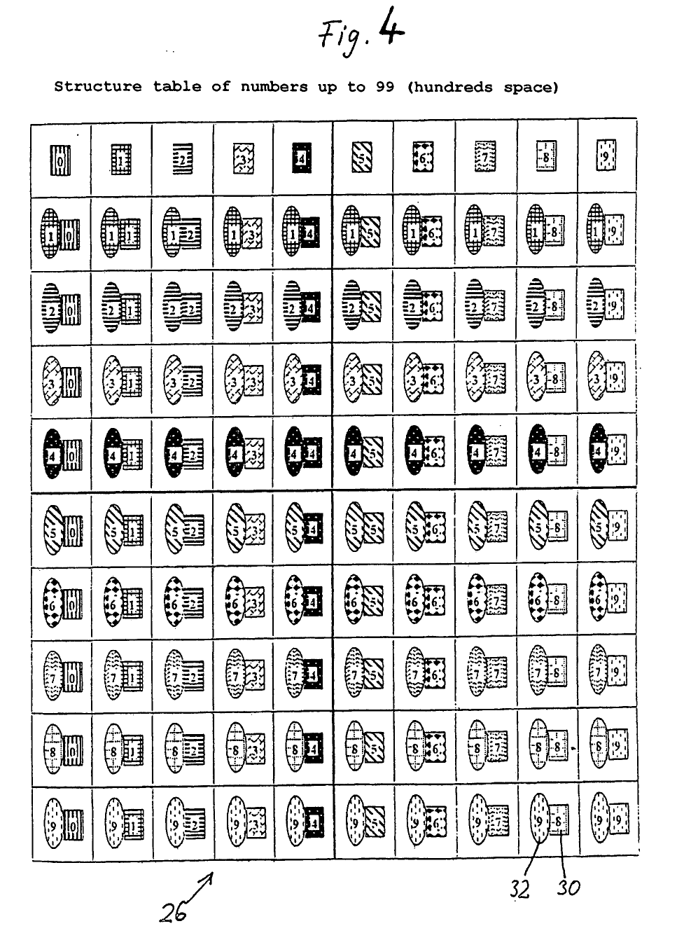

FIG. 4 a corresponding structure table of numbers for the numbers 0 to 99, in which the corresponding bodies only are shown symbolically and two-dimensionally, and

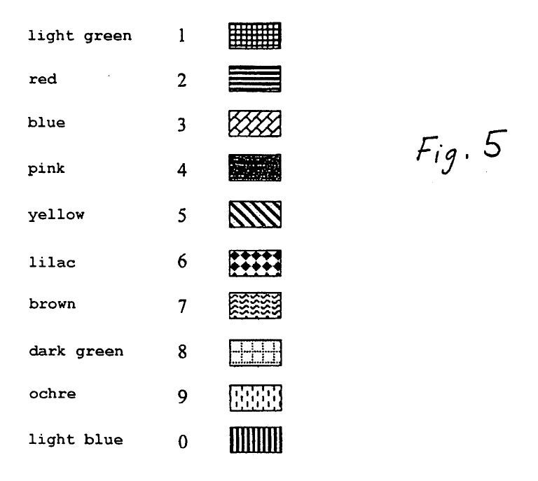

FIG. 5 a listing for the allocation of the hatching in FIGS. 1 to 4 to the corresponding colours.

According to the invention, an aid for learning the calculation is created consisting of differently coloured geometric bodies 10, 12, 14. Each body 10, 12, 14 is representing a number and is having a definite geometric shape and a definite colour. Here, each decimal step position, i.e. ones, tens, hundreds, and thousands, a definite geometric shape is assigned and each number 0 to 9 a colour is assigned. According to the present exemplary embodiment of the invention shown in FIGS. 1 to 4, number 1 has the colour light-green, number 2 the colour red, number 3 the colour dark-blue, number 4 the colour pink, number 5 the colour yellow, number 6 the colour lilac, number 7 the colour brown, number 8 the colour dark-green, number 9 the colour orange, and number 0 the colour light-blue. Of course for representing the individual numbers different colours are possible, too. Within one and the same aid according to the invention however the allocation of numbers and colour still has to be remain unchanged. Further according to the exemplary embodiment of the invention shown in the drawings each step position, i.e. each decimal position of the numbers, a geometric shape is assigned. In the present example the ones is assigned the shape of a cube, the tens is assigned the shape of a cylinder, the hundreds is assigned the shape of a right parallelepiped and thousand is assigned the shape of a parallelepiped having notches. Additionally, on each of the bodies 10, 12, 14, in addition to the corresponding colouring, the assigned number from 0 to 9 is printed.

To enable further calculations, additionally uncoloured bodies in the respective geometric shape can be provided by the means of which aggregates for representing a number can be formed.

According to the exemplary embodiment shown, a complete set of bodies for the aid according to the invention for learning calculation is consisting of fifty five uncoloured cubes, ten coloured cubes (having the numbers 0 to 9 and with each number being coloured with the respective colour), ten coloured cylinders (number 0 to 9 and each number coloured in the corresponding colour) as well as ten coloured right parallelepipeds (number 0 to 9 and each number coloured in the corresponding colour) as well as ten coloured right parallelepipeds having notches (number 0 to 9 and each number with the corresponding colour).

As a further aid for learning the calculation according to the invention structure tables of numbers 20, 22, 24, 26 are provided. FIG. 1 is showing such a structure table 20 of numbers for the numbers 1 to 100 in a three-dimensional representation of the corresponding bodies 10, 12, 14 corresponding to the respective numbers 1 to 100. The body 10 here is a cube having the colour light-green which is corresponding to the number 1. On the right side thereof a cube in red is following corresponding to the number 2 and so on up to the combination of a light-green cylinder with a light-green cube for the number 10. The cylinder-shaped bodies 12 followingly always are representing the respective tens position. On the structure table 20 of numbers shown in the first line the numbers 1 to 10 in the second line the numbers 11 to 20 and so on are positioned up to the tenth line containing the numbers 91 to 100. The hundred here always is an elongate right parallelepiped 14 in a light-green colour. The respective bodies 10, 12, 14 always in addition to their colour have the corresponding value of numbers printed on. Since the representation in the publications of the German Patent and Trademark Office always has to be in black and white, the corresponding colours are represented according to the legend in FIG. 5 as hatchings. The structure table of numbers shown in FIG. 1 therefore is showing the respective numbers 1 to 100 as these can be represented by means of the bodies 10, 12, 14 according to the invention in a three-dimensional representation. Additionally, the table is showing the function of the bodies 10, 12, 14 according to the invention as an aid for learning the calculation.

For pedagogic reasons it can be suitable, however, to show the corresponding structure table 22 of numbers with the numbers 1 to 100 in a more abstract way. This kind of representation is shown in FIG. 2 which instead of the three-dimensionally shown bodies 10, 12, 14 is containing corresponding two-dimensional areas 30, 32, 34 which, too, are shown in different geometric shapes and the same colour coding. In the present exemplary embodiment therefore the decimal step position Ones is shown by a square, the decimal step position Tens by an oval 32 and the decimal step position Hundreds by an oblong hexagonal 34.

FIG. 3 is showing a corresponding structure table 24 of numbers with a three-dimensional representation of the individual bodies 10, 12, 14 like in FIG. 1. In this case however it is the structure table of numbers from 0 to 99 which therefore is to be to show the “hundreds space”. Here in the first line the numbers 0 to 9, in the second line the numbers 10 to 19 and so on are positioned up to the tenth line containing the numbers 90 to 99.

FIG. 4 is showing a structure table 26 of numbers, too, for the numbers 0 to 99 as in FIG. 3, wherein here the decimal step positions however instead of the direct three-dimensional representation of the bodies are shown as two-dimensional areas as in FIG. 2.

FIG. 5 merely is showing the legend for allocating the hatchings used in the black and white drawings with the corresponding colours, wherein the corresponding designation of the colour is shown.

The invention, however, is not limited to the corresponding tables with the numbers 1 to 100 or 0 to 99. Contrary “partial spaces” can be represented as for example the numbers 0 to 19 or 1 to 20.

Tests with children having calculation disorder have shown that by means of the aid according to the invention described above substantial successes in learning calculation can be achieved which are unachievable with other pedagogic aids or are achievable with far more difficulty.

1-8. (canceled)

9. An aid for learning calculation comprising:
differently colored geometric bodies (10, 12, 14),
wherein each body represents a number and has a geometric shape and a color;
wherein each geometrical shape defines a decimal step position (ones, tens, hundreds, thousands); and
wherein each color defines a number.

10. The aid according to claim 9 wherein the geometric shapes of the bodies (10, 12, 14) are chosen such that the bodies (10, 12, 14) can be stacked above each other.

11. The aid according to claim 9 wherein
a step position “One” is assigned with a cube shape,
a step position “Ten” is assigned with a cylindrical shape,
a step position “Hundred” is assigned with a “right parallelepiped” shape, and
a step position “Thousands” is assigned with a “right parallelepiped” shape with notches.

12. The aid according to claim 9 wherein the corresponding number is inscribed on each colored body (10, 12, 14).

13. The aid according to claim 9 further comprising tables (20, 22, 24, 26) in which the numbers are depicted represented by the corresponding bodies (10, 12, 14) or corresponding two-dimensional areas (30, 32, 34).

14. The aid according to claim 13 wherein the tables (20, 22) include the numbers 1 to 100 depicted in ten lines and ten columns.

15. The aid according to claim 13 wherein the tables (24, 26) include the numbers 1 to 99 depicted in ten lines and ten columns.

16. The aid according to claim 9 further comprising uncolored bodies having corresponding geometric shapes.
